(19) United States
(12) Patent Application Publication
(10) Pub. No.: US 2016/0280150 A1
(43) Pub. Date: Sep. 29, 2016

(54) camera system, particularly for a vehicle, and a method for the manufacture thereof

(71) Applicant: ROBERT BOSCH GMBH, Stuttgart (DE)

(72) Inventors: Werner Steinberger, Immenstadt (DE); Stefan Timmermann, Burgberg (DE)

(21) Appl. No.: 14/777,896

(22) PCT Filed: Feb. 24, 2014
(86) PCT No.: PCT/EP2014/053496

§ 371 Date: Sep. 17, 2015

(30) Foreign Application Priority Data
Mar. 22, 2013 (DE) 10 2013 205 160.3

(51) Int. Cl. B60R 11/04; H04N 5/225

(52) U.S. Cl. CPC B60R 11/04; H04N 5/2254; H04N 5/2253

(57) ABSTRACT

A camera system for a vehicle includes: an imager module having a carrier device; a lens system accommodated on the carrier device; an image sensor mounted on the carrier device, for generating image signals, the image sensor being in contact with conductor tracks which run on or upon the carrier device; and a planar circuit carrier which is in contact with the conductor tracks of the carrier device for recording image signals, the conductor tracks not running in parallel to the circuit carrier. The carrier device includes (i) a first contact pad connected to one of the conductor tracks, and (ii) a second contact surface which is in contact with the first contact pad via a bond connection formed between the second contact surface and a contact area of the first contact pad, the contact area running in parallel to the second contact surface.

### BACKGROUND OF THE INVENTION

1. Field of the Invention

The present invention relates to a camera system for a vehicle, and to a method for manufacturing such a camera system.

2. Description of the Related Art

Camera systems for vehicles are used in particular for detecting an exterior space outside of the vehicle through a vehicle windshield and/or for detecting an interior of the vehicle. Camera systems and camera modules in general have a lens system, which includes a lens mount and at least one lens, an image sensor and a carrier device, on which the image sensor is mounted and with which it is contacted. This carrier device is designed as a circuit board, for example. The lens system is accommodated in a lens system mount, so that it is longitudinally adjustable to enable an adjustment. The lens system mount is generally mounted on the carrier device. In fixed-focus cameras, the lens system is inserted permanently into the lens system mount.

The imager module formed from a carrier device, a camera and an image sensor is subsequently contacted with a planar circuit carrier, generally a printed circuit board (PCB), on which electronic components, such as a microcontroller, for example, for activation of and readout from the image sensor and optionally interface units for contacting the camera system in the vehicle, for example, on the CAN bus, are provided. The imager module and the circuit carrier are generally accommodated in a camera housing, which may be fastened in the vehicle via a camera mount, for example. DE 10 2009 027 514 A1 describes one such camera system.

The shape of the camera housing is to be adapted to the respective mounting position in the vehicle. The longitudinal extent of the circuit carrier in particular may be obstructive when the installation space is narrow, for example, in the area of the windshield. Camera modules are therefore generally designed individually, i.e., specifically having a different position and layout of the circuit carrier with respect to the optical axis.

Disadvantages in general include the complex manufacture from a plurality of components having corresponding tolerances as well as the contact of the different components, in particular when there are different shapes and positions relative to one another.

### BRIEF SUMMARY OF THE INVENTION

According to the present invention, the carrier device has three-dimensional contours and has a lens system mounting area for mounting the lens and a conduction area, which has conductor tracks for contacting the image sensor. The image sensor may be fastened directly to the carrier device in particular, i.e., without complex chip sockets. In this way, the image sensor may be mounted in particular in the area of a recess or an opening in the carrier device, in particular in flip-chip technology, in which the sensitive sensor surface is directed through the recess to the lens system.

The number of components and thus also the tolerances are minimized due to such a design. The carrier device in particular may be designed as an MID (molded interconnect device) and may thus form the lens system mounting area and the conduction area and thereby provide conductor tracks for contacting the image sensor.

Contacting of the conduction area with the circuit carrier advantageously takes place in a (lower) end section of the carrier device. The end section or a lower edge of the carrier device may advantageously be placed in or through a recess in the circuit carrier and may thus be contacted with the bottom side of the circuit carrier, for example.

According to the present invention, it is recognized that the design of bond connections for contacting the conduction area of the carrier device and the circuit carrier may be problematic since it is difficult for technical reasons to apply bond connections or wire bonds between differently positioned contact surfaces, in particular also due to the tolerances. According to the present invention, it is therefore recognized that the contact surfaces should run in parallel to one another. It is also recognized here that this parallel arrangement in particular is more relevant than the height of the contact surfaces being the same, so that a vertical offset of the contact surfaces is fundamentally not such a disadvantage with respect to the plane of the contact surfaces.

Thus, according to the present invention, parallel contact surfaces or contact areas are formed.

According to one embodiment, the first contact pad of the carrier device is not planar but instead is designed to be curved. It advantageously has a convex curvature. A contact area in the curved first contact pads of the carrier device is selected, which runs in parallel to the second contact surface of the circuit carrier.

A parallel arrangement or orientation of two contact surfaces, of which at least one is nonplanar, is understood here to be a design in which a tangent or a tangential plane on the non-curved area runs in parallel to the other contact surface.

Due to the nonplanar design of the contact pad, a fitting contact area, which is parallel to the other contact surface, may thus be selected in each case in the event of different installation positions.

A few advantages are thus already achieved. Uniform carrier devices having curved contact pads may be formed and used in various camera systems. The curved contact pads may be formed at different installation angles of the conduction carrier plate with respect to the carrier device and with respect to its optical axis or its conduction area, there being nevertheless a secure contact, in that the position of a suitable first contact area of the first contact pad having a parallel alignment with the second contact surface of the circuit carrier plate is selected.

Thus, for different systems, only reprogramming of the contact tool is necessary without any new structural design of relevant larger components.

Multiple contacts may be contacted to one another by placing the first contact pads and second contact pads side by side laterally, so that essentially identical or similar bond connections are created and may thus be calculated jointly.

According to an alternative embodiment, parallel contact surfaces may be created by fastening a bond contact part onto the circuit carrier. The bond contact part may have a support surface and a contact surface in particular, which form an angle to one another, which corresponds to the installation angle of the conduction carrier plate relative to the conduction area or the optical axis of the carrier device. The bond contact part may thus be formed as a wedge shape in particular. It may be formed as a metal piece, for example, and may be fastened conductively with its support surface to a contact pad of the circuit carrier, for example, by soldering or gluing with the aid of a conductive adhesive.

A parallel alignment may thus be achieved in turn by relatively simple means, so that the first contact pad of the carrier device may be formed on a lower edge, for example, an edge situated at a right angle.

This embodiment thus also makes it possible to establish a secure connection and contact inexpensively. Only the corresponding bond contact parts are to be applied, for example, as inexpensive angle brackets.

### BRIEF DESCRIPTION OF THE DRAWINGS

FIG. 1 shows a camera module according to one specific embodiment of the present invention in a longitudinal section.

FIG. 2 shows in partial images a), b), and c) detailed enlargements from FIG. 1 with the contact of the imager module on the circuit board.

FIGS. 3 and 4 show bond connections at different angles between the MID carrier and the circuit board of the specific embodiment shown in FIGS. 1 and 2.

FIG. 5 shows a representation of another specific embodiment of the present invention.

### DETAILED DESCRIPTION OF THE INVENTION

A camera module 1 is provided for mounting in or on a vehicle 2, for example, on a vehicle window 3, a roof liner or a rearview mirror on vehicle 2, for example. Camera module 1 has a lens system 4, a carrier device 6 and an image sensor 7 mounted on carrier device 6. Carrier device 6 has a three-dimensional injection-molded shape, in particular as an MID (molded interconnect device) component having a three-dimensional contouring and conductor tracks 8 on its surface. Image signals S1 of image sensor 7 are read out via conductor tracks 8.

In addition, a circuit board 10, as a planar circuit carrier, including electronic components 11, 12 and a camera housing 14, designed here in two parts, including housing parts 14a and 14b are provided, carrier device 6 and circuit board 10 being accommodated in housing interior 15. Electronic components 11, 12 are also used in particular record, process and output image signals S1 of image sensor 7. They may constitute a microcontroller 11 and a memory 12, for example, if necessary, also an interface for connection to a data network in vehicle 2.

In the specific embodiment shown here, image sensor 7 is mounted using flip-chip technology, i.e., carrier device 6 has a recess 16 through which image sensor 7 is directed at lens system 4. Image sensor 7 may therefore be mounted and contacted directly via solder bumps on MID carrier device 6, for example. Fundamentally, however, other mounting variants are also possible here. Camera module 1 is advantageously manufactured in a fixed-focus design, i.e., having a fixed focal distance and object distance, by affixing lens system 4 during its manufacture to carrier device 6 in a suitable position by adhesive bonding, friction welding or additional locking means, for example, after focusing, for example, by detecting a test pattern under evaluation of image signals S1 of image sensor 7.

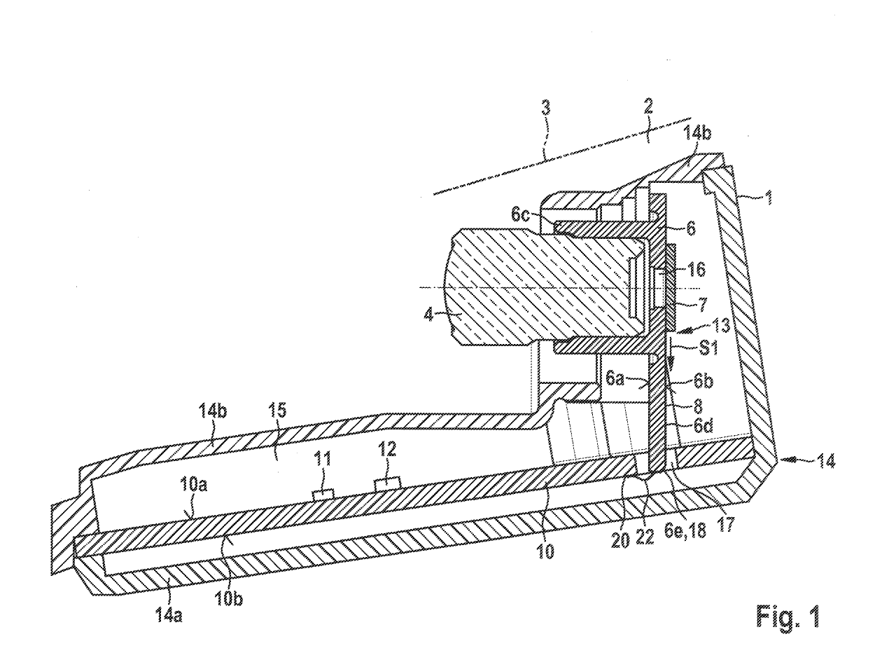

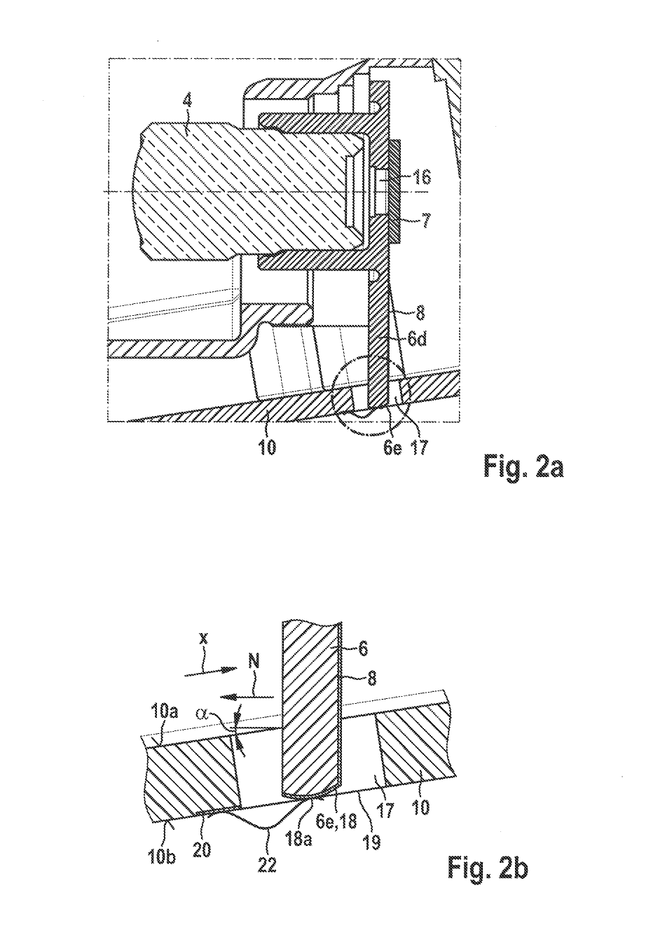

MID carrier device 6 has a lens system mounting area 6c, which is designed essentially in the form of a bowl or a pot and has recess 16 in its bottom and also has a conduction area 6d extending to circuit board 10, conductor tracks 8 running on its front side 6a and/or back side 6b, contacting image sensor 7. According to FIG. 2, conductor tracks 8 run to a lower edge 6e of MID carrier device 6. First contact pads (interface pads) 18 are formed on lower edge 6e. For example, two or more first contact pads 18 may be formed side by side on lower edge 6e, i.e., with a distance between them, in the direction perpendicular to the plane of the drawing in FIGS. 1 and 2. First contact pads 18 are connected to conductor tracks 8, which contact image sensor 7. Thus, first contact pads 18 and conductor tracks 8 may be formed by a structured metallization (metallization plane). First contact pads 18 may advantageously extend over the entire lower edge 6e. A continuous structured metallization may thus extend over back side 6b up to lower edge 6e, for example.

Circuit board 10 has a recess 17, into or through which lower edge 6e of MID carrier device 6 is placed. Here, circuit board 10 may basically also contact MID carrier device 6. However, these are advantageously designed without contact, i.e., without direct contact, with one another. Both MID carrier device 6 and circuit board 10 are advantageously mounted or fastened in housing 14.

Two contact pads 20 are formed on top side 10a and/or bottom side 10b of conductor surface 10, i.e., bottom side 10b here. First contact pads 18 of MID carrier device 6 are contacted with second contact pads 20 of circuit board 10 with the aid of bond connections 22.

First contact pads 18 are designed to be nonplanar. They are advantageously designed to be convex, i.e., curved outwardly, as shown in FIGS. 1 through 4.

Lower edge 6e is therefore advantageously designed with a corresponding convex shape, so that contact pads 18 are formed by metallization and structuring of areas of lower edge 6e having the curved shape.

MID carrier device 6 including mounted image sensor 7 and accommodated lens system 4 form an imager module 13, which is subsequently mounted in housing 14 and is contacted with circuit board 10.

Bond connections 22 contact first contact pads 18 in a contact area 18a, to which an applied tangent 19 or tangential plane runs in parallel to second contact pad 20. It is basically not necessary for tangent 19 according to partial image b) to lie on a level with second contact pads 20. This means that second contact pads 20 do not necessarily lie in tangential plane 19 but instead they may also be offset in parallel to one another, as shown in the alternative of partial image c) of FIG. 2.

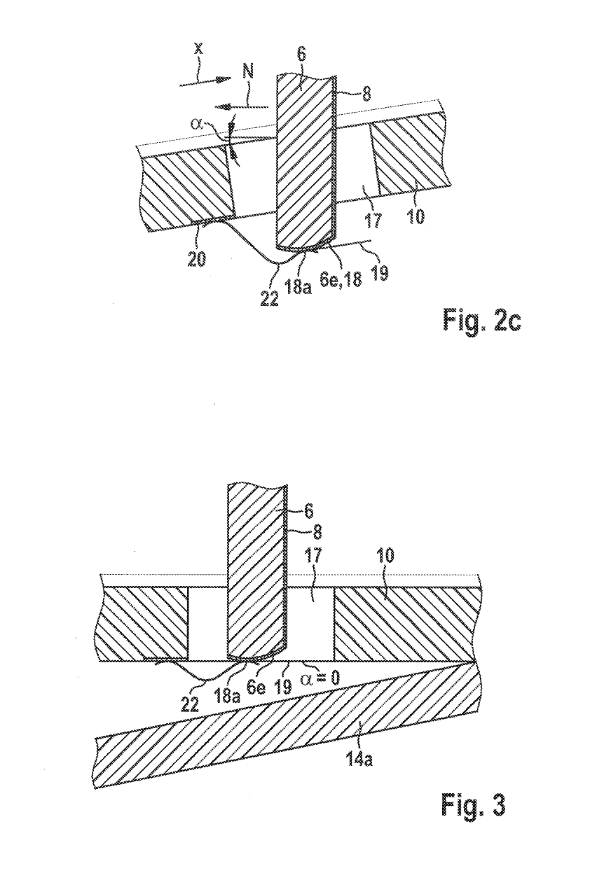

First contact pads 18 thus allow for a plurality of different tangential planes 19 via their longitudinal extension, i.e., in the x direction (or −x direction) in FIG. 2. Circuit board 10 is at an installation angle α to optical axis A and, accordingly, to normal N on conduction area 6d. Thus, installation angle α is zero when circuit board 10 or its top side 10a and bottom side 10b are in parallel to optical axis A. Due to a suitable curvature range or an adequate angle of arc of first contact pads 18, a corresponding tangential plane 19 running in parallel to circuit board 10 and thus its second contact pads 20 may thus be found for a plurality of different or differently inclined circuit boards 10, i.e., having different installation angles α. This is shown in FIGS. 3 and 4 for elucidation.

FIG. 3 shows circuit board 10 essentially perpendicular or orthogonal to conduction area 6d of carrier device 6.

Installation angle α is thus α=0. In FIG. 4, however, installation angle α assumes a larger value. The design in FIG. 2 is between the specific embodiments in FIGS. 3 and 4 with regard to installation angle α. In the specific embodiments of FIGS. 3 and 4, conduction area 6d of circuit carrier 6 may also pass through recess 17 and may thus protrude as far as below bottom side 10b of circuit board 10.

Thus, with regard to the process engineering, the contact device used, which sets bond connections 22, may be programmed accordingly, so that it selects a contact area 18a of first contact pads 18, whose tangential plane 19 runs in parallel to second contact pads 20. Thus, only a corresponding reprogramming of the contact device is necessary for setting bond connections 22 at different installation angles α of circuit board 10 with respect to circuit area 6b.

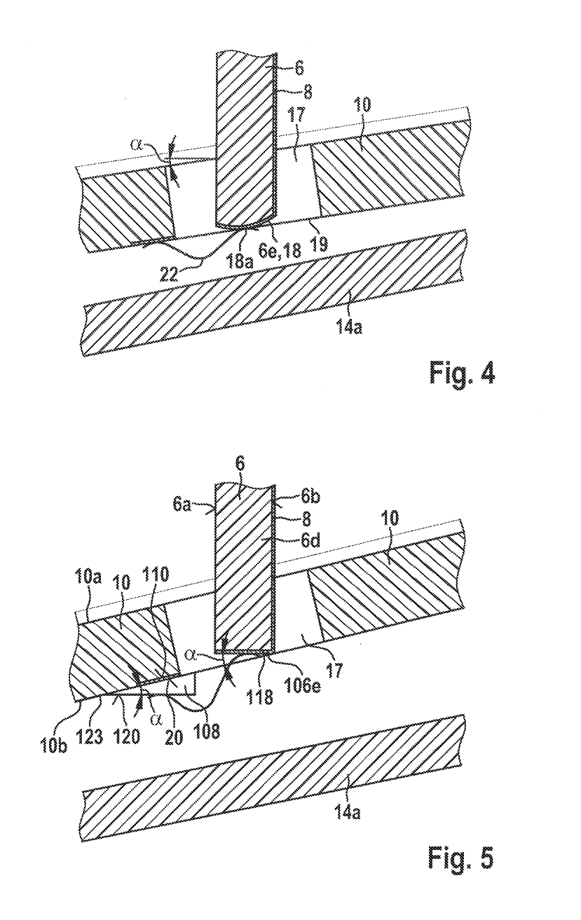

FIG. 5 shows an embodiment as an alternative to FIGS. 1 through 4, in which identical or similar features are shown with identical or similar reference numerals as in FIGS. 1 through 4.

In the specific embodiment in FIG. 5, lower edge 106e of conduction area 6d is designed to be flat, in particular having an orthogonal profile to front side 6a and back side 6b of circuit region 6d, i.e., as an end surface at a right angle. Top side 10a and bottom side 10b of circuit board 10 thus run at an installation angle α relative to lower edge 106e. In this specific embodiment, a bond contact part 108 is conductively fastened with its flat support surface 110 to bottom side 10b of circuit board 10, for example, soldered or fastened with the aid of a conductive adhesive, to contact a conductor track 123. Bond contact part 108 in particular may be soldered or glued to a second contact pad 20. Bond contact part 108 has a second contact surface 120 at installation angle α relative to its support surface 110 and thus also to second contact pad 120. Bond connections 22 are placed between second contact surface 120 and first contact pad 118 running in parallel to one another and having a corresponding height offset, if necessary—as shown here. It is preferable for multiple bond contact parts 108 to be placed side by side, i.e., perpendicular to the plane of the drawing. Multiple first contact pads 118 are formed side by side accordingly.

In the specific embodiment in FIG. 5, first contact pads 118 thus form the first contact areas, which are contacted with the second contact surfaces.

Thus, in all specific embodiments, bond connections 22 may be placed or applied between parallel contact surfaces. In all specific embodiments, the contact may take place with both bottom side 10b and top side 10a of circuit board 10.

First contact pads 18 and 118 may basically also be formed in a position other than lower edge 6e, 106e.

1-19. (canceled)

20. A camera system for a vehicle, comprising:
an imager module having a carrier device;
a lens system accommodated on the carrier device;
an image sensor mounted on the carrier device for generating image signals, the image sensor contacting conductor tracks which extend one of on or upon the carrier device; and
a circuit carrier for recording the image signals, the circuit carrier contacting the conductor tracks of the carrier device;
wherein:
the conductor tracks do not extend in parallel to the circuit carrier;
the carrier device includes at least one first contact pad connected to one of the conductor tracks;
the circuit carrier includes at least one second contact surface;
the first contact pad and the second contact surface are connected to one another via a bond connection; and
the bond connection is formed between the contact surface and a contact area of the first contact pad extending in parallel to the second contact surface.

21. The camera system as recited in claim 20, wherein multiple first contact pads are situated side by side, and multiple second contact surfaces are situated side by side, and wherein the first contact pads and multiple second contact surfaces are contacted by multiple bond connections.

22. The camera system as recited in claim 20, wherein the carrier device has a three-dimensional contour and is an injection-molded part having the conductor tracks extending on the surface of the injection-molded part.

23. The camera system as recited in claim 22, wherein the three-dimensionally contoured carrier device has a lens system mounting area in which (i) the lens system is accommodated, and (ii) the image sensor is mounted and has a conduction area including the conductor tracks, the conduction area extending from the lens system mounting area to the circuit carrier, and wherein the at least one first contact pad is formed on an end section of the conduction area.

24. The camera system as recited in claim 23, wherein:
the circuit carrier has a recess;
the end section of the carrier device is one of set in or through the recess from a top side of the circuit carrier;
the end section of the carrier device including the at least one first contact pad is one of situated in the recess or protrudes through the recess; and
the at least one contact surface is formed on a bottom side of the circuit carrier.

25. The camera system as recited in claim 23, wherein the end section has a lower edge on which the at least one first contact pad is formed.

26. The camera system as recited in claim 25, wherein:
the at least one first contact pad extends over one of a non-planar or curved area of the lower edge; and
the contact area of the first contact pad has one of a tangent or tangential plane which extends in parallel to the second contact surface of the circuit carrier.

27. The camera system as recited in claim 26, wherein one of the lower edge or a section of the lower edge on which the first contact pad is formed has a convex curvature.

28. The camera system as recited in claim 20, wherein the at least one second contact surface is a second contact pad formed by metallization on one of a top side or bottom side of the circuit carrier.

29. The camera system as recited in claim 20, wherein:
a support surface of a bond contact part made of a conductive material is fastened conductively to at least one of a second contact pad of the circuit carrier and the first contact pad of the carrier device; and
the second contact surface is formed by a top side of the bond contact part which is inclined relative to the support surface of the bond contract part; and
at least one of the first and second contact pads accommodates the support surface of the bond contract part in such a way that the bond connection connects to parallel contact surfaces.

30. The camera system as recited in claim 29, wherein:
the bond contact part is conductively attached to at least one of a bottom side of the circuit carrier; and
an end section of the carrier device is one of situated in a recess of the circuit carrier or protrudes through the recess;
the bond contact part is formed in a wedge shape and has the support surface in contact with the bottom side of the circuit carrier and has a contact surface extending at an installation angle relative to the support surface; and
the end section of the carrier device extends at the installation angle relative to the bottom side of the circuit carrier plate.

31. The camera system as recited in claim 20, wherein at least one of the top side and the bottom side of the flat circuit carrier extends at an oblique installation angle relative to the conduction area, the oblique installation angle being more than 0° and less than 90°.

32. The camera system as recited in claim 20, wherein the first contact surface and the second contact surface are offset in height relative to one another perpendicularly to the plane of the surface.

33. The camera system as recited in claim 20, further comprising:
a camera housing in which the imager module and the planar circuit carrier are accommodated and fastened in the camera housing.

34. The camera system as recited in claim 20, wherein the circuit carrier is planar and electronic components are mounted on the circuit carrier for at least one of recording the image signals and connection in the vehicle.

35. A method for manufacturing a camera system, comprising:
forming an imager module which includes: a carrier device made of a plastic material having a three-dimensional contouring, which has a lens system mounting area and a conduction area; a lens system inserted into the lens system mounting area; and an image sensor which is fastened to the carrier device, wherein conductor tracks and first contact pads are formed one of in or on the conduction area, the image sensor being contacted with the conductor tracks, and the conductor tracks leading to the first contact pads; and
contacting the first contact pads with contact surfaces of a circuit carrier with the aid of bond connections, the circuit carrier extending at an oblique installation angle between 0° and 90° relative to the conduction area of the carrier device, wherein the bond connections are formed between the second contact surfaces of the circuit carrier and the first contact areas of the first contact pads extending in parallel to the second contact surfaces.

36. The method as recited in claim 35, wherein the conduction area of the carrier device is placed one of in or through a recess of the circuit carrier in such a way that, on an end section of the conduction area, the first contact pads are formed on a non-planar area, the bond connection being placed in a contact area of the first contact pad having one of a tangent or tangential plane which extends in parallel to the second contact area of the circuit carrier.

37. The method as recited in claim 36, wherein to form a camera module, an installation angle of the circuit carrier relative to one of the conduction area, a normal of the conduction area, or the optical axis of the lens system mounting area of the carrier device is initially ascertained, and the contact area of the non-planar first contact pad is selected in such a way that one of a tangent or tangential plane of the non-planar first contact pad extends in parallel to the circuit carrier.

38. The method as recited in claim 35, wherein multiple bond connections are placed side by side in a lateral direction and connect contact surfaces which are offset relative to one another in the vertical direction.
